(19) United States
(12) Patent Application Publication
(10) Pub. No.: US 2008/0040116 A1
(43) Pub. Date: Feb. 14, 2008

(54) System for and Method of Providing Improved Intelligibility of Television Audio for the Hearing Impaired

(75) Inventors: John Cronin, Jericho, VT (US); Tom Hunt, Shelburne, VT (US)

Correspondence Address: NORRIS MCLAUGHLIN & MARCUS, P.A., P O BOX 1018, SOMERVILLE, NJ, 08876, US

(73) Assignee: JOHNSON & JOHNSON CONSUMER COMPANIES, INC., Skillman, NJ (US)

(21) Appl. No.: 11/570,461

(22) PCT Filed: Jun. 9, 2005
(86) PCT No.: PCT/US05/20273

§ 371 Date: Sep. 20, 2007

Related U.S. Application Data
(60) Provisional application No. 60/579,946, filed on Jun. 15, 2004.
(60) Provisional application No. 60/579,947, filed on Jun. 15, 2004.

(51) Int. Cl. G10L 15/26; G10L 13/00; H04R 25/00

(52) U.S. Cl. 704/261; 181/129; 704/271; 704/E15.043; 704/E13.001

(57) ABSTRACT

The present invention is a TV hearing system that generally includes an analog or digital TV broadcast signal feeding a hearing health interface that subsequently drives the input of a standard television. The hearing health interface further includes a receiver, a digital signal processor (DSP) logic block, a driver, an input/output (I/O) device, and optionally a direct audio driver and/or a radio frequency (RF) transmitter. Pre-established data representing a personal hearing profile of a hearing impaired user that includes correction factors for compensating for the hearing problem is supplied to the DSP logic block. The DSP logic block then selectively modifies the audio relating to the TV broadcast and presents the enhanced audio to the user. Additionally, the present invention includes a business method of establishing a hearing health network to which users may subscribe.

### CROSS-REFERENCED TO RELATED APPLICATION

This application claims the benefit of U.S. Provisional Application No. 60/579,946 filed Jun. 15, 2004, assigned to the assignee of this application and incorporated by reference herein. The subject matter of International application Ser. No. ______, filed Jun. ______, 2005 and entitled “A System for and Method of Conveniently and Automatically Testing the Hearing of a Person”, assigned to the assignee of this application, is related to this application.

### FIELD OF THE INVENTION

The present invention relates to audio delivery systems in a television. More particularly, the present invention relates to enhancing the audio delivery system of a television for improved intelligibility by the hearing impaired.

### BACKGROUND OF THE INVENTION

More than 25 million Americans have hearing loss, including one out of four people older than 65. Hearing loss may come from infections, strokes, head injuries, some medicines, tumors, other medical problems, or even excessive earwax. It can also result from repeated exposure to very loud noise, such as music, power tools, or jet engines. Changes in the way the ear works as a person ages can also affect hearing.

For most people who have a hearing loss, there are ways to correct or compensate for the problem, such as medicines, hearing aids, and other medical devices, as is well known. There are several technical challenges in improving the effectiveness of a hearing aid in correcting or compensating for the hearing loss. For example, a standard hearing aid equally amplifies all components of a received audio input, thus amplifying background noise along with the audio of interest, such as voice or music. This creates a problem for the user of the hearing aid in that the background noise may render the voice or music unintelligible or, at the very least, difficult to distinguish. More specifically, in a scenario where a hearing aid user is watching and listening to a television (TV), the user may desire to better distinguish the voice within the television audio output from other sounds, such as background music or special effects sounds.

Closed captioning, which is the process of converting the audio portion of a video production into text that is displayed on a television screen, is a well-known visual method of assisting a hearing-impaired person with the spoken content of a television broadcast. However, this is not as convenient as simply listening to the voice audio output directly. Furthermore, if the person also has a visual impairment, or is illiterate, closed captioning is not effective. What is needed is a way for a hearing-impaired individual to better aurally distinguish in real time between voice output and any other audio output of a television.

U.S. Pat. No. 6,226,605, incorporated by reference herein, describes the use of a digital acoustic signal processing apparatus arranged by employing a memory device for storing a digital acoustic signal, an acoustic frequency feature enhancing device for enhancing an acoustic frequency feature, and a low-speed sound reproducing device for changing a speed of the stored voice to reproduce this voice as a low speed into a hearing aid and an appliance with an acoustic output, such as a hearing aid, television receiver, or a telephone receiver. After the voice has been stored in the memory device, a process for enhancing the frequency characteristic in order to fit the frequency characteristic to the individual hearing characteristic and the voice reproducing environment is carried out and presented to the user. The user can repeatedly listen the voice stored in the memory device with employment of a control device for controlling the voice reproducing operation. While the digital voice processing apparatus of the '605 patent provides a suitable method of enhancing the frequency characteristic of the voice presented to the user, it does not present this enhanced audio output to the user in real time and is therefore not suitable for a real-time television application.

It is therefore an object of the invention to provide a way for a hearing-impaired individual to better aurally distinguish in real time between voice output and any other audio output of a television.

Televisions today are commonly capable of displaying text associated with the closed captioning function. The user may enable or disable the closed captioning feature using menus associated with his or her particular television set. However, the user has no control over the placement of this text upon the video screen, nor does the user typically have control over the text font, text size, text color, or background. Furthermore, the text displayed using the closed-captioning function of a television set is typically not displayed verbatim, nor is the text display synchronized with the mouth movement of the characters associated with the television production. What is needed is a user-controlled method of controlling the text display output associated with a television broadcast.

U.S. Pat. No. 5,774,857, incorporated by reference herein, describes apparatuses, systems, and a method that provide for a visual display of speech, such as the visual display of a received audio signal in telecommunications, especially useful for the hearing impaired. The preferred apparatus includes a network interface that is coupled to a first communication channel to receive an audio signal; a radio frequency (RF) modulator to convert a baseband output video signal to an RF output video signal and to transmit the RF output video signal on a second communication channel for video display; and a processor coupled to the network interface and to the RF modulator for running a set of program instructions to convert the received audio signal to a text representation of speech, and to further convert the text to the baseband output video signal. The RF output video signal, when displayed on a video display, provides the visual display of speech. While the apparatuses, systems, and method of the '857 patent provide a suitable method for the visual display of speech, it does not provide user control of the displayed text.

It is therefore another object of this invention to provide a user-controlled method of controlling the text display output associated with a television broadcast.

### SUMMARY OF THE INVENTION

The present invention is a TV hearing system and method that utilizes a pre-established personal hearing profile of a hearing-impaired user to selectively enhance the audio output of a standard television set, thereby providing better intelligibility of the audio as heard by the hearing-impaired user. Data representing the personal hearing profile of the user is supplied to a hearing health interface of the present invention via a network connection and/or via a user I/O port. Secondly, the system and method of the present invention provides improved user control of the closed captioning text display by overriding and/or bypassing the closed captioning feature of the user's television via the hearing health interface that generates the closed captioning text display.

Thus, the present invention provides for a multimedia hearing assistance interface comprising a receiver for receiving an audio data signal; a hearing data signal interface for receiving user hearing profile data including digital signal processor (“DSP”) correction factors, (e.g., wherein the hearing profile data is transmitted from a central database over a communications network or contained in a local input device such as a floppy disk); a digital signal processor (“DSP”) coupled to a memory, wherein the memory is for storing the user hearing profile data, wherein the DSP analyzes frequency spectrum of the audio data signal for generating representative digital audio data and modifies the digital audio data using the DSP correction factors, wherein the DSP generates an interface output audio signal based on the digital audio data, wherein the interface audio signal is compatible with an input audio signal requirement of at least one of a multimedia device (e.g. television, stereo receiver) or an audio sound generating means of a hearing aid, wherein the hearing aid has wireless (radio frequency (“RF”)) signal receiving capabilities.

In a further embodiment of the interface, the receiver is for receiving a video signal including text captioning data, wherein the DSP is selectably operable to extract the text captioning data from the video signal and to generate DSP-modified text captioning data having a user defined text presentation characteristic (e.g. font size, positioning in a video frame).

In a further embodiment of the interface, the receiver is for receiving a video signal including text captioning data, wherein the DSP is selectably operable to extract the text captioning data from the video signal and to generate a synthesized word enhanced with the DSP correction factors, wherein the enhanced synthesized word corresponds to a selected word represented in the text captioning data and received at the interface as part of the user profile data.

In a further embodiment of the interface, the DSP generates a synthesized audio or text word based on identification of speech frequencies in the audio data signal.

In still a further embodiment, the DSP modifies the synthesized audio word using the DSP correction factors.

The present invention also resides in a method for providing hearing loss enhancement to a multimedia signal comprising providing a hearing loss profile database containing hearing loss profiles for a respective plurality of individuals, wherein the database is accessible over a communications network; providing a multimedia hearing assistance interface (as described above); requiring submission of authorization data before permitting access to the database; transmitting at least one of an audio data signal or a video signal including text captioning data; and generating at least one of an enhanced audio or text captioning data signal at the multimedia interface based on the hearing loss profile accessed from the database and the audio data signal or the video signal.

In addition, present invention further provides a method for providing hearing loss enhancement to a multimedia signal comprising: providing a hearing loss profile database containing hearing loss profiles for a respective plurality of individuals; receiving a user request for at least one of an enhanced audio data signal or enhanced text captioning data, wherein the request is received from a communications network and includes user identification; requiring submission of the user identification data before permitting access to the database; generating at least one of an enhanced audio signal or text captioning data signal based on the hearing loss profile for the user; and transmitting at least one of the enhanced audio signal of the text captioning data signal to the user over a communications network.

In a further embodiment, the method includes requiring payment of a fee by the user before the generating and transmitting of the enhanced signals are performed.

### BRIEF DESCRIPTION OF THE DRAWINGS

FIG. 1 illustrates a high-level block diagram of a TV hearing system in accordance with a first embodiment of the invention.

FIG. 2 illustrates a high-level block diagram of a hearing health interface in accordance with a first embodiment of the invention.

FIG. 3 illustrates a high-level block diagram of a TV hearing system in accordance with a second embodiment of the invention.

FIG. 4 illustrates a high-level block diagram of a hearing health interface in accordance with a second embodiment of the invention.

FIG. 5 illustrates a high-level block diagram of a TV hearing system in accordance with a third embodiment of the invention.

FIG. 6 illustrates a high-level block diagram of a hearing health interface in accordance with a third embodiment of the invention.

FIG. 7 illustrates a flow diagram of a hearing health business method in accordance with the invention.

### DESCRIPTION OF THE INVENTION

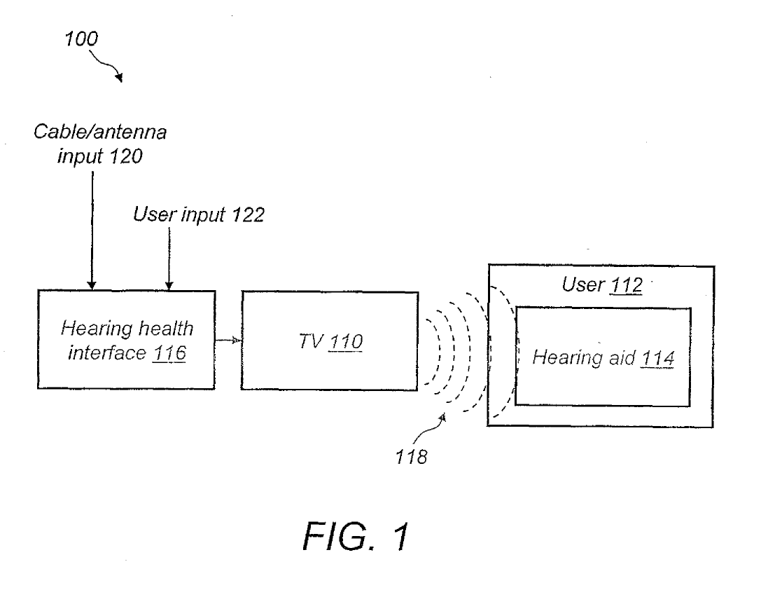

FIG. 1 illustrates a high-level block diagram of a TV hearing system 100 in accordance with a first embodiment of the invention. TV hearing system 100 includes a TV 110, a user 112 wearing a hearing aid 114, and a hearing health interface 116. TV 110 is any standard home-use television set capable of receiving a television broadcast via a cable or antenna feed. User 112 is representative of any hearing-impaired person utilizing a standard hearing aid, such as hearing aid 114, to more easily hear the audio associated with the broadcast of TV 110. More specifically, an audio output 118 of TV 110 is received by hearing aid 114 worn by user 112, who is typically located in close proximity to TV 110.

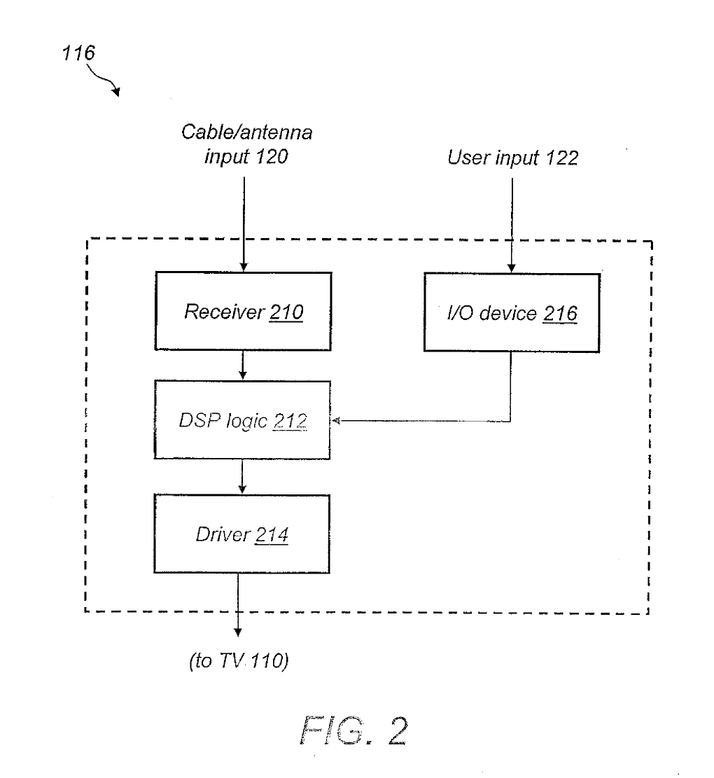

Hearing health interface 116 is a device that utilizes a pre-established hearing profile of user 112 to modify the audio portion of a televised broadcast as received via a cable/antenna input 120. Hearing health interface 116 is capable of enhancing the audio signal specific to the hearing profile of user 112. Hearing health interface 116 is further detailed in reference to FIG. 2 below. Cable/antenna input 120 is electrically connected to a first input of hearing health interface 116 and is representative of a standard analog audio/video feed for receiving a television broadcast, such as a coaxial cable or an antenna wire. The data associated with the pre-established hearing profile is supplied to hearing health interface 116 by user 112 via a user input 122, which is a second input of hearing health interface 116.

FIG. 2 illustrates a high-level block diagram of hearing health interface 116 in accordance with a first embodiment of the invention. Hearing health interface 116 includes a receiver 210, a digital signal processor (DSP) logic 212, a driver 214, and an input/output (I/O) device 216.

Receiver 210 is any standard very-high-frequency (VHF) (30 to 300 MHz) or ultra-high-frequency (UHF) (300 MHz to 3 GHz) receiver circuit that is capable of receiving a TV broadcast signal having both a video and audio component via cable/antenna input 120. Receiver 210 performs standard functions that allow the analog input signal of cable/antenna input 120 to be processed via any downstream stages of hearing health interface 116. For example, the input signal is converted from analog into digital data. A digital data output of receiver 210 is electrically connected to an input of DSP logic 212.

DSP logic 212 is a standard digital signal processor that is a special-purpose microprocessor, usually for handling audio or video signals. DSP logic 212 is designed to handle signal-processing applications, such as real-time audio and video compression, very quickly. Signals are converted from analog into digital data. Once converted, the digital data's components can be isolated, analyzed, and rearranged by DSP logic 212 through specific algorithms more easily than in the original analog form. The signal can then be enhanced and modified by DSP logic 212. DSP logic 212 contains the necessary digital logic to store and execute signal processing software algorithms. Included (but not shown) in DSP logic 212 is non-volatile memory. Other embodiments may include volatile memory and other support logic. A digital data output of DSP logic 212 is electrically connected to an input of driver 214. Driver 214 is any standard driver circuit that is capable of receiving the digital signal from DSP logic 212, performing a standard digital-to-analog conversion function and subsequently driving the TV broadcast signal to TV 110. Thus, an output signal of driver 214 is electrically connected to a signal input port of TV 110.

I/O device 216 is representative of any standard method by which a user might supply input data to an electronic device, such as a floppy disk drive, a compact disc (CD) drive, a memory stick, a serial input port, a keypad device, or any combination thereof.

With reference to FIGS. 1 and 2, the operation of TV hearing system 100 is as follows. The analog TV broadcast signal is received by cable/antenna input 120 and is fed into receiver 210 of hearing health interface 116. Receiver 210 converts the analog signal to digital data and subsequently feeds this digital data into DSP logic 212.

User 112 feeds the data associated with his/her pre-established personal hearing profile into I/O device 216 via user input 122. This data is provided via standard data formats and includes information such as a frequency vs. amplitude profile of user 112. The creation of an individual's personal hearing profile is further described in reference to “A System for and Method of Conveniently and Automatically Testing the Hearing of a Person”, pending International Application PCT/US2005/______, filed Jun. ______, 2005, claiming priority of U.S. Provisional Application Ser. No. 60/579,947, filed Jun. 15, 2004, assigned to the assignee of this application and incorporated by reference herein. The hearing profile data of user 112 is subsequently transferred to DSP logic 212.

DSP logic 212 is programmed with algorithms for enhancing the audio portion of the digital data from receiver 210 according to the specific hearing profile data of user 112, which is received via I/O device 216. For example, specific frequencies, perhaps those associated with voice data, are modified based upon the frequency vs. amplitude profile of user 112. DSP logic 212 performs a frequency spectrum analysis of the broadcast signal from receiver 210 and combines this analysis with the information with the desired correction factors as specified within the hearing profile data of user 112. In this way the audio signal that is ultimately fed into TV 110 via driver 214 is modified, for example, such that those frequencies that user 112 would normally have difficulty hearing are enhanced specifically for improved intelligibility by user 112. Subsequently, the enhanced audio output 118 of TV 110 is received by hearing aid 114 of user 112, who is located in close proximity to TV 110.

Optionally, user 112 may select, via user input 122, to have a text representation of the speech associated with the TV broadcast displayed upon the video screen of TV 110. The text representation of the speech is not accomplished by the conventional closed captioning feature of TV 110. Instead, the text representation of the speech is accomplished by DSP logic 212 directly extracting the closed captioning information that is already a component of the TV broadcast signal. This text is then combined with the video signal feeding TV 110 via driver 214 for display upon the screen of TV 110. Furthermore, user 112 may control, via user input 122, the text placement upon the screen of TV 110, as well as the text font, text size, text color, and text background.

In an alternative embodiment, the closed captioning information that is already a component of the TV broadcast may be converted to a synthesized voice. For example, a lookup table is generated by DSP logic 212 that contains a list of the most commonly used words associated with synthesized words that have been enhanced based upon the frequency vs. amplitude hearing profile data of user 112. Then, according to this lookup table, the enhanced synthesized voice is received by hearing aid 114 of user 112 via audio output 118 of TV 110. An example of an application that generates a synthesized voice from text data is DECTalk™ (Fonix Corp, Salt Lake City, Utah), which is a text-to-speech technology that transforms ordinary text into natural-sounding, highly intelligible speech. In order to further enhance the auditory experience of the synthesized voice signal, the DSP may also contain programming means to identify and isolate the speech or voice portion of the audio signal, as well as means to reduce or eliminate as much as possible said portion, in favor of the synthesized voice signal. A further preferred means allows the remaining portion of the audio signal, i.e. that portion not associated with voice or speech, to remain in the output audio signal, together with the synthesized speech signal.

In yet another alternative embodiment, as speech-to-text technology improves, it is anticipated that DSP logic 212 may accurately determine frequencies that are typically associated with speech directly from the broadcast signal, thereby allowing a synthesized voice or a text display to be generated directly from the broadcast signal and subsequently heard or seen, respectively, by user 112. As described above, the synthesized voice is modified and enhanced according a lookup table associated with the specific hearing profile of user 112. Those skilled in the art will acknowledge that present speech-to-text technology is limited, for example, in its ability to accurately distinguish voice from background noise. However, a TV broadcast consisting largely of speech with little background noise, such as a talk show or a news broadcast, may be accurately interpreted using current speech-to-text technology, thereby allowing the generation of text which in turn may be converted to a synthesized voice that is enhanced according to the lookup table. An example of speech-to-text software is Dragon NaturallySpeaking® software (ScanSoft, Inc. Peabody, Mass.), which is speech-to-text software used to create documents from voice.

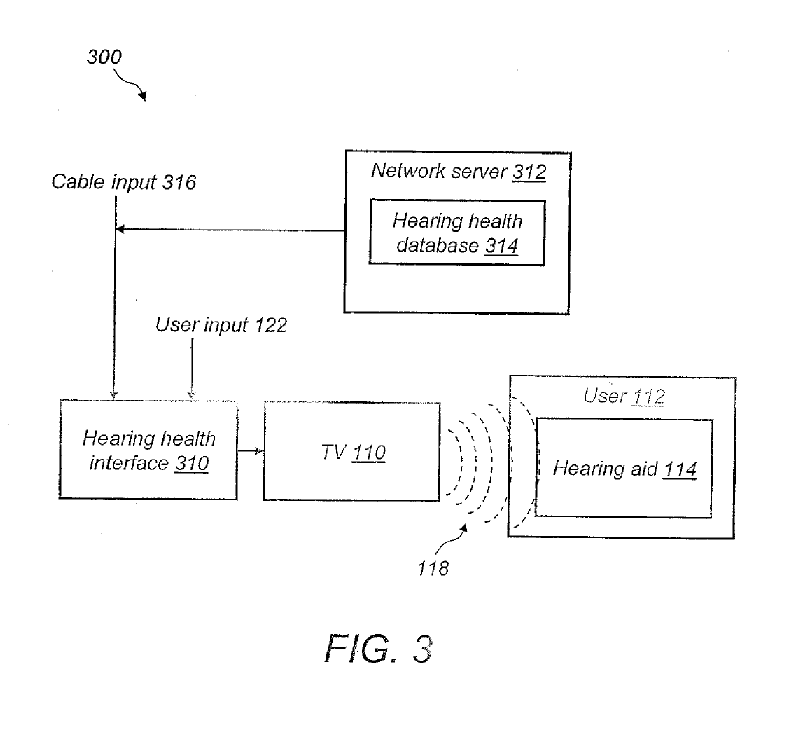

FIG. 3 illustrates a high-level block diagram of a TV hearing system 300 in accordance with a second embodiment of the invention. TV hearing system 300 includes TV 110 producing audio output 118 and user 112 wearing hearing aid 114, as described in FIGS. 1 and 2. TV hearing system 300 further includes a hearing health interface 310 and a network server 312 that further includes a hearing health database 314.

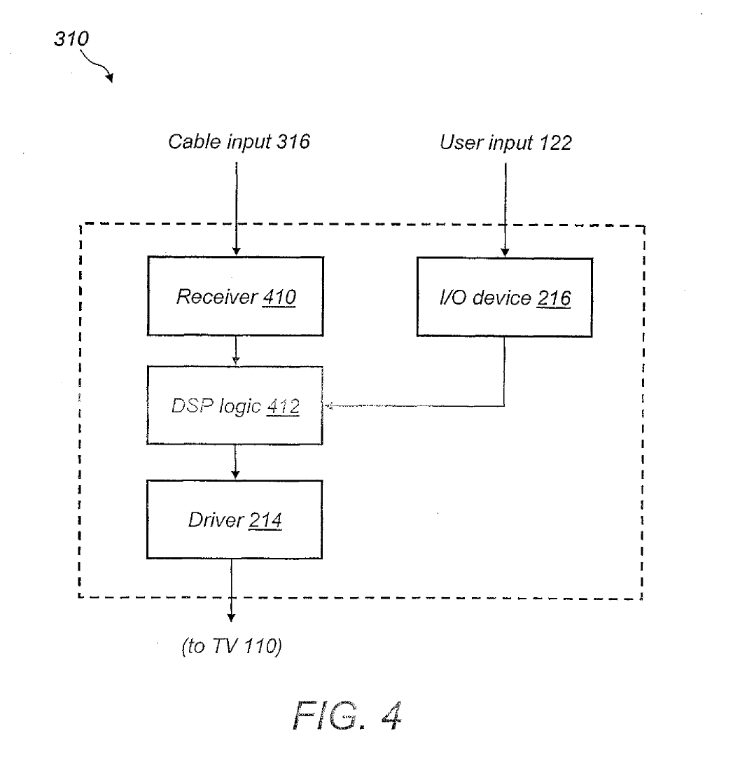

Like hearing health interface 116, hearing health interface 310 is a device the utilizes a pre-established hearing profile of user 112 to modify the audio portion of the TV broadcast as received via a cable input 316. Hearing health interface 310 is capable of enhancing the audio signal specific to the hearing profile of user 112. Hearing health interface 310 is further detailed in reference to FIG. 4 below. Cable input 316 is electrically connected to a first input of hearing health interface 310 and is representative of a standard digital audio/video feed for receiving a television broadcast, such as a coaxial cable. The data associated with the pre-established hearing profile, as described in FIGS. 1 and 2, is optionally supplied to hearing health interface 310 by user 112 via user input 122, which is a second input of hearing health interface 310.

Network server 312 is a conventional network server of a conventional network system that may include a plurality of TV hearing systems 300, all of which access a TV broadcast signal and a network connection via cable input 316. User 112 gains access to network server 312 by purchasing a subscription to a hearing health service, whereby hearing health database 314 is generated that includes the personal hearing profiles of hearing-impaired individuals, such as user 112. Consequently, the personal hearing profile of user 112 is available to hearing health interface 310 of TV hearing systems 300 either by accessing hearing health database 314 of network server 312 using cable input 316 or, alternatively, by using user input 122.

FIG. 4 illustrates a high-level block diagram of hearing health interface 310 in accordance with a second embodiment of the invention. Hearing health interface 310 includes a receiver 410 and a DSP logic 412, as well as driver 214 and I/O device 216, as described in FIG. 2.

Receiver 410 is any standard receiver circuit that is capable of receiving, via cable input 316, a digital broadcast TV signal along with the broadband signal associated with network server 312, such as provided by a wide area network (WAN) or a digital subscriber line (DSL). Alternatively, the connection of receiver 410 to network server 312 is a feed separate from cable input 316, for example, a standard telephone connection feeding a modem (not shown) within receiver 410. In the case of a modem, receiver 410 performs an analog-to-digital conversion. A digital data output of receiver 410 is electrically connected to an input of DSP logic 412.

DSP logic 412 provides the same functions as described in reference to DSP logic 212 of FIG. 2. However, DSP logic 412 provides the additional function of selecting the personal hearing profile from one of two sources, i.e., from I/O device 216 or from hearing health database 314 of network server 312 via receiver 410. A digital data output of DSP logic 412 is electrically connected to an input of driver 214.

With reference to FIGS. 3 and 4, the operation of TV hearing system 300 is as follows. The digital TV broadcast signal is received by cable input 316 and fed into receiver 410 of hearing health interface 310. Receiver 410 subsequently feeds this digital data into DSP logic 412.

User 112 supplies the data associated with his/her pre-established personal hearing profile to hearing health interface 310 either by I/O device 216 via user input 122 or by accessing hearing health database 314 of network server 312 using cable input 316. In either case, I/O device 216 may serve as a user interface, for example, to allow user 112 to initiate the download of his/her personal hearing profile from hearing health database 314 or to enter a user ID, etc. As described in FIG. 2, this data is provided via standard data formats and includes information such as a frequency vs. amplitude profile of user 112. The hearing profile data of user 112 is subsequently transferred to DSP logic 412.

DSP logic 412 is identical in form and function to DSP logic 212 as described in FIG. 2 but with the further capability of being able to receive and process the data associated with the hearing profile of user 112 from either I/O device 216 or receiver 410. Like DSP logic 212, the output of DSP logic 412 includes audio data that is enhanced specifically for improved intelligibility by user 112 based upon the hearing profile of user 112. The enhanced audio output of DSP logic 412 is ultimately fed into TV 110 via driver 214. Subsequently, the enhanced audio output 118 of TV 110 is received by hearing aid 114 of user 112 who is located in close proximity to TV 110.

Optionally, user 112 may select via user input 122 to have a text representation of the speech associated with the TV broadcast displayed upon the video screen of TV 110. The text representation of the speech is not accomplished by the conventional closed captioning feature of TV 110. Instead, the text representation of the speech is accomplished by DSP logic 412 directly extracting the closed captioning information that is already a component of the TV broadcast signal. This text is then combined with the video signal feeding TV 110 via driver 214 for display upon the screen of TV 110. Furthermore, user 112 may control, via user input 122, the text placement upon the screen of TV 110, as well as the text font, text size, text color, and text background.

Similarly, all embodiments associated with closed captioning and synthesized voice, as described in reference to hearing health interface 116 of FIGS. 1 and 2, are applicable to hearing health interface 310. However, in this case the lookup table associated with generating the synthesized voice is either generated by DSP logic 412 as described in FIG. 4, or alternatively is generated at network server 312 and is already included in the personal hearing profile of user 112 within hearing health database 314 before being received by DSP logic 412.

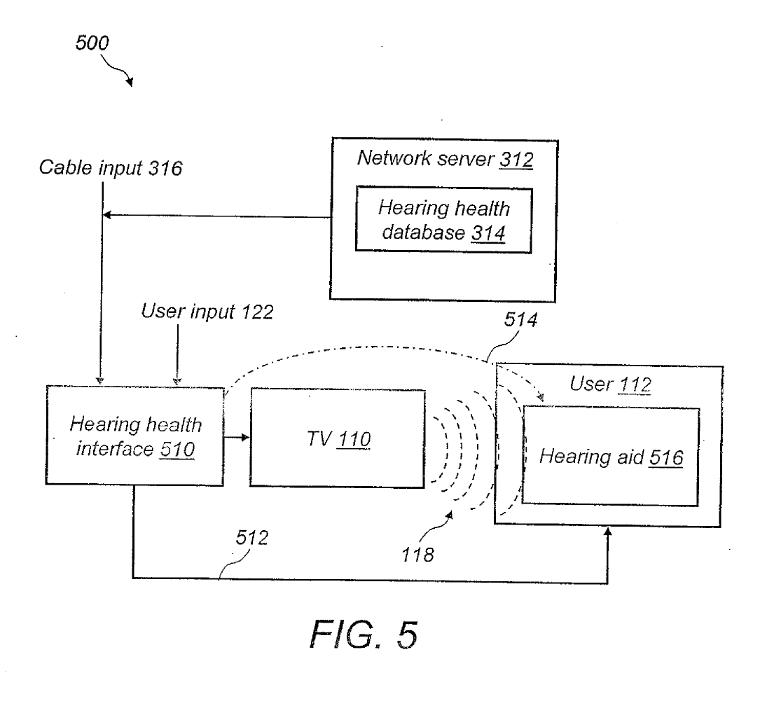

FIG. 5 illustrates a high level block diagram of a TV hearing system 500 in accordance with a third embodiment of the invention. TV hearing system 500 includes TV 110 and user 112, as described in FIGS. 1 and 2, as well as network server 312 and hearing health database 314, as described in FIGS. 3 and 4. TV hearing system 500 further includes a hearing health interface 510. Lastly, user 112 of TV hearing system 500 is wearing a hearing aid 516 that performs the conventional amplification function and additionally includes an RF receiver that may optionally be activated.

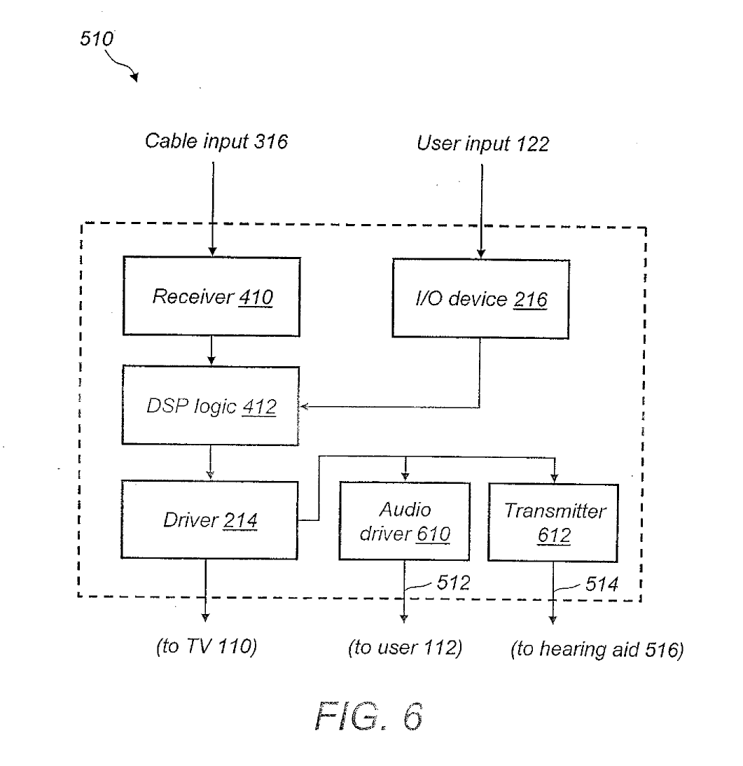

Like hearing health interface 310, hearing health interface 510 is a device the utilizes a pre-established hearing profile of user 112 to modify the audio portion of the TV broadcast as received via cable input 316. Hearing health interface 510 is capable of enhancing the audio signal specific to the hearing profile of user 112. However, hearing health interface 510 provides two outputs that user 112 may access directly, i.e., a direct audio output 512 and an RF output 514. Hearing health interface 510 is further detailed in reference to FIG. 6 below.

FIG. 6 illustrates a high-level block diagram of a hearing health interface 510 in accordance with a third embodiment of the invention. Hearing health interface 510 includes driver 214 and I/O device 216, as described in FIG. 2, and receiver 410 and DSP logic 412, as described in FIG. 4. Hearing health interface 510 further includes an audio driver 610 and a transmitter 612, both driven by an output of driver 214.

Hearing health interface 510 performs all the functions as described in reference to hearing health interface 116 and hearing health interface 310 but with the additional feature of allowing user 112 direct access to the audio associated with the TV broadcast without the need of audio output 118 of TV 110. In fact, audio output 118 of TV 110 may optionally be disabled. More specifically, audio driver 610 is, for example, suitable to drive a standard set of headphones that are worn by user 112 in combination with hearing aid 516. In this case, a standard headphone jack is provided for direct audio output 512 within hearing health interface 510. Alternatively, user 112 may access the audio associated with the TV broadcast via an RF transmission performed by transmitter 612 that generates RF output 514 that is received by the RF receiver within hearing aid 516 of user 112. The RF receiver within hearing aid 516 is tuned to the frequency of RF output 514 generated by transmitter 612. Both direct audio output 512 and RF output 514 provide user 112 with the enhanced audio based upon his/her personal hearing profile as developed by DSP logic 412. A main feature of allowing user 112 direct access to the audio associated with the TV broadcast via audio driver 610 or transmitter 612 is that the effects of the room acoustics associated with the location of TV 110, which may be problematic for user 112 who is hearing impaired, are eliminated.

Alternatively, audio driver 610 and transmitter 612 may provide multiple outputs to accommodate multiple hearing impaired users 112. These multiple outputs are personalized based upon the personal hearing profile of each user 112 that is accessed by DSP logic 412 via hearing health database 314 or I/O device 216.

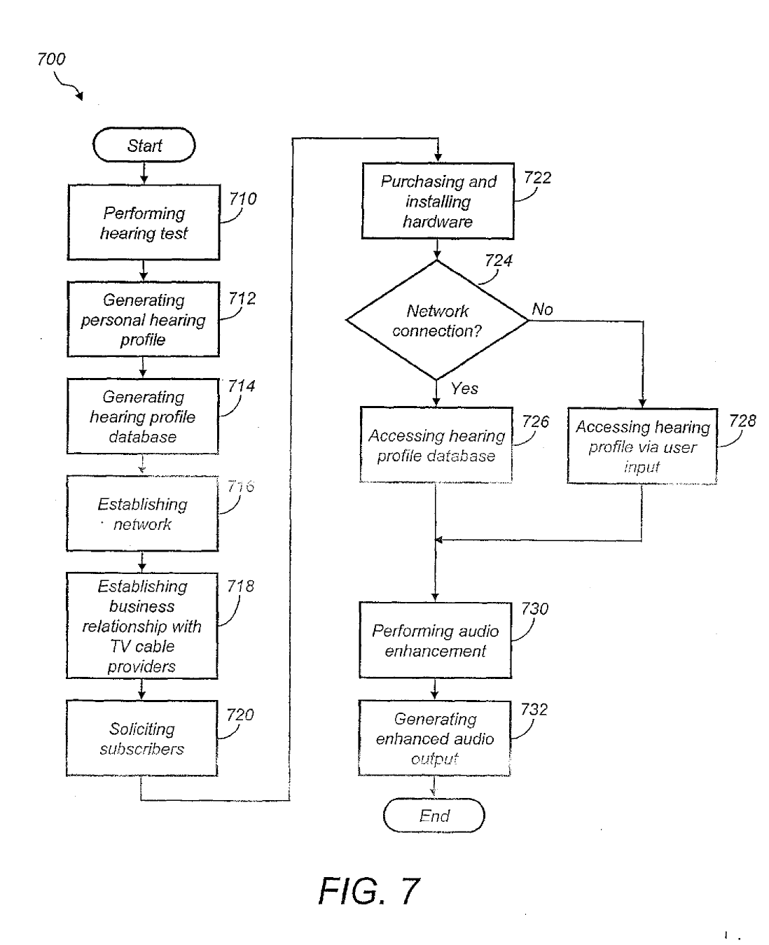

FIG. 7 illustrates a flow diagram of a hearing health business method 700 in accordance with the invention. Method 700 includes the steps of:

Step 710: Performing Hearing Test

In this step, a hearing test is performed by an audiologist to determine the hearing health of an individual, such as user 112, using conventional methods. Method 700 proceeds to step 712.

Step 712: Generating Personal Hearing Profile

In this step, based upon the results of the hearing test of step 710, a personal hearing profile is generated for user 112 that contains data associated with the most suitable correction factors for compensating for the hearing problem of user 112. Data contained within the personal hearing profile may, for example, relate to a frequency vs. amplitude profile of user 112. A computer data file of any well-known data format is generated that contains the personal hearing profile of user 112. Method 700 proceeds to step 714.

Step 714: Generating Hearing Profile Database

In this step, the personal hearing profiles of multiple users 112 are compiled upon a central computer to form a hearing profile database, such as hearing health database 314. Each user 112 must authorize the owner of the central computer to include his/her personal hearing profile within the database. Method 700 proceeds to step 716.

Step 716. Establishing Network

In this step, a broadband hearing health network is established by a network server, such as network server 312, by which an authorized user of the hearing health network may access hearing health database 314. Method 700 proceeds to step 718.

Step 718: Establishing Business Relationship with TV Cable Providers

In this step, the owner of the hearing health network establishes a business partnership with one or more TV broadband cable providers, by which the hearing health network may be accessed for home use. Method 700 proceeds to step 720.

Step 720: Soliciting Subscribers

In this step, the owner of the hearing health network solicits subscribers to the network via well-known marketing techniques, such as telemarketing, television advertising, radio advertising, printed advertising, or via local audiologists or physicians. Method 700 proceeds to step 722.

Step 722: Purchasing and Installing Hardware

In this step, the subscriber to the hearing health network purchases and installs the hardware necessary to access the network. For example, the subscriber purchases and installs hearing health interface 116, hearing health interface 310, or hearing health interface 510. Method 700 proceeds to step 724.

Step 724: Network Connection?

In this decision step, if the subscriber has a network connection via a modem or a TV broadband cable, method 700 proceeds to step 726. If the subscriber has no such network connection, method 700 proceeds to step 728.

Step 726: Accessing Hearing Profile Database

In this step, the subscriber accesses the hearing health network via hearing health interface 116, hearing health interface 310, or hearing health interface 510, thereby allowing the subscriber's personal hearing profile to be downloaded from hearing health database 314 to hearing health interface 116, hearing health interface 310, or hearing health interface 510. Method 700 proceeds to step 730.

Step 728: Accessing Hearing Profile Via User Input

In this step, the owner of the hearing health network provides the subscriber, such as user 112, with his/her hearing profile data file via, for example, a floppy disk or CD. This hearing profile data is supplied to hearing health interface 116, hearing health interface 310, or hearing health interface 510 via user input 122 and I/O device 216. Method 700 proceeds to step 730.

Step 730: Performing Audio Enhancement

In this step, the audio associated with the TV broadcast is modified and thereby enhanced based upon the subscriber's personal hearing profile by the DSP, such as DSP logic 212 or 412, within hearing health interface 116, hearing health interface 310, or hearing health interface 510. Method 700 proceeds to step 732.

Step 732: Generating Enhanced Audio Output

In this step, hearing health interface 116, hearing health interface 310, or hearing health interface 510 presents the enhanced audio output to user 112 via audio output 118 of TV 110 or, in the case of hearing health interface 510, via direct audio output 512 or RF output 514. Method 700 ends.

Those skilled in the art will appreciate that the system, method, and concepts disclosed in reference to FIGS. 1 through 7 are applicable to any medium by which audio is generated to be heard by a hearing-impaired person, for example, a radio broadcast via a home radio system or a movie presentation via a movie theater. It is also understood that references to cable television also encompass other forms of transmission such as satellite.

1. A multimedia hearing assistance interface comprising:
a receiver for receiving an audio data signal and conveying said signal to a digital signal processor;
a means for conveying user preference data to the digital signal processor;
the digital signal processor (“DSP”) for modifying at least a portion of the audio data signal based on user preference data conveyed to the DSP; and
a driver for generating an output audio signal based on the audio data signal received from the DSP.

2. The interface of claim 1, wherein the receiver comprises means for converting the audio data signal from an analog to a digital signal, and for conveying the digital signal to the DSP.

3. The interface of claim 1, wherein the driver comprises means for converting the audio data signal from the DSP from a digital to an analog signal.

4. The interface of claim 1, wherein the means for conveying user preference data is an input/output device or a network server containing stored user preference data.

5. The interface of claim 1, wherein the user preference data comprises personal hearing profile data.

6. The interface of claim 5, wherein the personal hearing profile data comprises a frequency vs. amplitude profile.

7. The interface of claim 1, wherein the DSP further comprises means for performing a frequency spectrum analysis on the audio data signal.

8. The interface of claim 7, wherein the personal hearing profile data comprises a frequency vs. amplitude profile, and wherein the DSP further comprises means for modifying certain frequencies of the audio data signal based on the frequency vs. amplitude profile and the frequency spectrum analysis.

9. The interface of claim 1, wherein the audio data signal is a television signal.

10. The interface of claim 9, wherein the driver comprises means for conveying the output audio signal to a television.

11. The interface of claim 9, wherein the driver comprises means for conveying the output audio signal directly to an audio signal receiving device.

12. The interface of claim 11, wherein the audio signal receiving device is a hearing aid.

13. The interface of claim 11, wherein the output audio signal is conveyed to the audio signal receiving device by radio frequency transmission.

14. A multimedia text display assistance interface comprising:
a receiver for receiving a data signal comprising audio and video data and text data corresponding to the audio data, and conveying said signal to a digital signal processor;
a means for conveying user input to the digital signal processor;
the digital signal processor (“DSP”) for modifying the text data portion of the data signal based on said user input conveyed to the DSP; and
a driver for generating an output signal comprising video and text based on the modified data signal received from the DSP.

15. The interface of claim 14, wherein the data signal is a television signal and the text data received by the receiver is closed-captioning data.

16. The interface of claim 15, wherein the user input comprises one or more parameters relative to the placement and display of text on a television screen, chosen from the group consisting of location, font, size, color and background.

17. A multimedia hearing assistance interface comprising:
a receiver for receiving a data signal comprising audio and video data and text data corresponding to the audio data, and conveying said signal to a digital signal processor;
the digital signal processor (“DSP”) for converting the text data portion of the data signal to a synthesized voice data signal; and
a driver for generating an output signal comprising video and the synthesized voice data signal received from the DSP.

18. The interface of claim 17, wherein the data signal is a television signal and the text data received by the receiver is closed-captioning data.

19. The interface of claim 17, further comprising a means for conveying to the DSP personal user hearing profile data comprising frequency vs. amplitude data, and wherein the synthesized voice data signal is generated based on said hearing profile data.

20. The interface of claim 17, wherein the DSP comprises means for analyzing the frequency of the audio portion of the data signal received from the receiver in order to identify that portion of the signal which corresponds to voice, and means for reducing or eliminating the voice component in favor of the synthesized voice data signal.

21. The interface of claim 17, wherein the driver comprises means for conveying the output audio signal to a television.

22. The interface of claim 17, wherein the driver comprises means for conveying the output audio signal directly to an audio signal receiving device.

23. The interface of claim 17, wherein the audio signal receiving device is a hearing aid.

24. The interface of claim 17, wherein the output audio signal is conveyed to the audio signal receiving device by radio frequency transmission.

25. A multimedia hearing assistance interface comprising:
a receiver for receiving an audio data signal and conveying said signal to a digital signal processor;
the digital signal processor (“DSP”) for analyzing the frequency of the audio data signal received from the receiver in order to identify that portion of the signal which corresponds to voice, and for converting the voice portion to a synthesized speech data signal; and
a driver for generating an output audio signal comprising the synthesized speech data signal received from the DSP.

26. The interface of claim 25, wherein the DSP further comprises means for reducing or eliminating the voice component of the data signal received from the receiver in favor of the synthesized voice data signal, such that the output audio signal comprises a remainder of the received audio signal along with the synthesized speech data.

27. The interface of claim 25, further comprising a means for conveying to the DSP personal user hearing profile data comprising frequency vs. amplitude data, and wherein the synthesized voice data signal is generated based on said hearing profile data.

28. A method for providing multimedia hearing assistance, comprising the steps of:
receiving an audio data signal;
providing user preference data;
modifying at least a portion of the received audio data signal based on said user preference data; and
generating an output audio signal based on the modified audio data signal.

29. The method of claim 28, wherein between the receiving step and the modifying step, the audio data signal is converted from an analog to a digital signal.

30. The method of claim 28, further comprising converting the modified audio data signal from a digital to an analog signal.

31. The method of claim 28, wherein the user preference data is provided by way of an input/output device or a network server containing stored user preference data.

32. The method of claim 28, wherein the user preference data comprises personal hearing profile data.

33. The interface of claim 32, wherein the personal hearing profile data comprises a frequency vs. amplitude profile.

34. The method of claim 28, further comprising performing a frequency spectrum analysis on the received audio data signal.

35. The method of claim 34, wherein the personal hearing profile data comprises a frequency vs. amplitude profile, and further comprising the step of modifying certain frequencies of the received audio data signal based on the frequency vs. amplitude profile and the frequency spectrum analysis.

36. The method of claim 28, wherein the audio data signal is a television signal.

37. The method of claim 36, comprising conveying the output audio signal to a television.

38. The method of claim 28, further comprising conveying the output audio signal directly to an audio signal receiving device.

39. The method of claim 38, wherein the audio signal receiving device is a hearing aid.

40. The method of claim 39, wherein the output audio signal is conveyed to the audio signal receiving device by radio frequency transmission.

41. A method for providing text display assistance, comprising the steps of:
receiving a data signal comprising audio and video data and text data corresponding to the audio data;
providing user input;
modifying the text data portion of the data signal based on said user input; and
generating an output signal comprising video and text based on the modified data signal.

42. The method of claim 41, wherein the data signal is a television signal and the text data received by the receiver is closed-captioning data.

43. The method of claim 42, wherein the user input comprises one or more parameters relative to the placement and display of text on a television screen, chosen from the group consisting of location, font, size, color and background.

44. A method for providing hearing assistance, comprising the steps of:
receiving a data signal comprising audio and video data and text data corresponding to the audio data;
converting the text data portion of the data signal to a synthesized voice data signal; and
generating an output signal comprising video and the synthesized voice data signal.

45. The method of claim 44, wherein the data signal is a television signal and the text data received by the receiver is closed-captioning data.

46. The method of claim 44, further comprising providing personal user hearing profile data comprising frequency vs. amplitude data, and wherein the synthesized voice data signal is generated based on said hearing profile data.

47. The method of claim 44, further comprising analyzing the frequency of the audio portion of the data signal received in order to identify that portion of the signal which corresponds to voice, and reducing or eliminating the voice component in favor of the synthesized voice data signal.

48. The method of claim 44, further comprising conveying the output audio signal to a television.

49. The method of claim 44, further comprising conveying the output audio signal directly to an audio signal receiving device.

50. The method of claim 44, wherein the audio signal receiving device is a hearing aid.

51. The method of claim 49, wherein the output audio signal is conveyed to the audio signal receiving device by radio frequency transmission.

52. A method for providing hearing assistance, comprising the steps of:
receiving an audio data signal;
analyzing the frequency of the audio data signal received from the receiver in order to identify that portion of the signal which corresponds to voice, and converting the voice portion to a synthesized speech data signal; and
generating an output audio signal comprising the synthesized speech data signal.

53. The method of claim 52, further comprising reducing or eliminating the voice component of the data signal received in favor of the synthesized voice data signal, such that the output audio signal comprises a remainder of the received audio signal along with the synthesized speech data.

54. The method of claim 52, further comprising providing personal user hearing profile data comprising frequency vs. amplitude data, wherein the synthesized voice data signal is generated based on said hearing profile data.

55. A method for providing hearing assistance to a plurality of users, comprising the steps of:
performing a hearing test on a user to ascertain any hearing problems for said user,
generating a personal hearing profile for the user based on said hearing test, said profile comprising data associated with suitable correction factors for compensating said hearing problems,
generating and compiling a hearing profile database comprising personal hearing profiles of a plurality of users,
establishing a broadband hearing health network operable on a network server for providing access to the hearing profile database, by which an authorized user may access his personal hearing profile data,
establishing a relationship with one or more cable or satellite television providers,
obtaining subscribers to the network,
purchasing and installing hardware to provide access for the subscriber to the network,
accessing personal hearing profile by the user/subscriber from the hearing profile database by way of a network connection or by way of an input device or direct input;
performing audio enhancement of a television broadcast based on the personal hearing profile; and
generating enhanced audio output.
